(19) United States
(12) Patent Application Publication
(10) Pub. No.: US 2007/0225478 A1
(43) Pub. Date: Sep. 27, 2007

(54) Rhenium Catalyst Supported on Modified Alumina and Use Thereof in the Metathesis Reaction of Olefins

(76) Inventors: Cecilia Querci, Novara (IT); Aldo Bosetti, Vercelli (IT); Antonio Gennaro, Cameri-Novara (IT); Rinaldo Guerrini, Novara (IT); Matteo Russo, Cerano-Novara (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/579,054

(22) PCT Filed: Mar. 8, 2005
(86) PCT No.: PCT/EP05/02478

§ 371 Date: Mar. 9, 2007

(30) Foreign Application Priority Data
Apr. 29, 2004 (IT) MI2004A000855

(51) Int. Cl. B01J 23/36; B01J 21/04; B01J 23/84

(52) U.S. Cl. 528/485; 502/342; 502/346; 502/351; 502/355; 585/647

(57) ABSTRACT

A heterogeneous catalyst is described, active in the metathesis reaction of olefins comprising alumina as inert carrier and a rhenium compound as active component, characterized in that rhenium is present in an amount of less than 5% by weight with respect to the total preferably from 1 to 4% by weight, and the inert carrier is impregnated with at least one inorganic halide selected from FeCl₃, CuCl₂, TiCl₄, RuCl₃, ZnCl₂ and NH₄Cl, and/or the corresponding bromides or iodides and, subsequently, treated at a high temperature.

The present invention relates to a process for the preparation of a heterogeneous catalyst containing alumina as inert carrier, rhenium as the first active catalytic component and an inorganic halide, introduced either before the supporting of the rhenium or contemporaneously therewith, as the second active catalytic component.

The activation of the heterogeneous catalyst thus prepared is effected by means of thermal treatment followed by a rapid final cooling.

The present invention also relates to the use of said catalyst in the metathesis reaction of olefins.

A metathesis reaction, also known as dismutation or disproportionation of olefins, is a reaction of great practical interest which can be used, for example, for balancing the weight of olefins resulting from steam cracking.

When olefins are treated in the presence of suitable catalysts, they are converted to other olefins in a reaction in which the alkylidene groups (R¹R²C═) are inter-exchanged with a process schematically represented by the following equation:

$$\begin{matrix}{R}^{1} {R}^{2} C = {CR}^{1} {R}^{2} & & {R}^{1} {R}^{2} C = {CR}^{3} {R}^{4} \\ + & ⟷ & + \\ {R}^{3} {R}^{4} C = {CR}^{3} {R}^{4} & & {R}^{1} {R}^{2} C = {CR}^{3} {R}^{4}\end{matrix}$$

Heterogeneous catalysts essentially consisting of rhenium derivatives supported on inert materials (for example silica or alumina) are known to be active in the metathesis of olefins. For example, U.S. Pat. No. 3,641,189 and U.S. Pat. No. 3,676,520 describe the preparation of these materials and their use in the metathesis of olefins.

In the preparation of this catalyst, the active component is normally introduced onto the surface of the carrier through impregnation. In this reaction, the carrier is mixed with a solution in which the active component has been dissolved. When the solvent is removed by evaporation, the active component remains inside the carrier particles.

With these catalysts, however, it is necessary for the active component to be present in amounts ranging from 5 to 7% and, in spite of this, not particularly high yields have been observed, whereas, in the case of higher olefins, there is also a poor selectivity, often due to secondary isomerization reactions of double bonds (J. Mol. Cat: 46, 1988, 119-130 and App. Catal., 70, 1991, 295-306).

With the aim of overcoming the above limits, it has been found that by treating alumina with HCl, the catalyst activity is improved, even if secondary isomerization reactions still remain (J. Catal. 150, 46-55, 1994).

It has now been found that it is possible to overcome the above-mentioned drawbacks and to obtain optimum catalyst performances, using decidedly lower amounts of active component, by means of the catalyst of the present invention containing alumina as inert carrier, rhenium as the first active component and a suitable inorganic halide, introduced before the rhenium is supported or contemporaneously therewith, as the second active component. The activation of the heterogeneous catalyst thus prepared is effected by thermal treatment followed by a rapid final cooling.

Said catalyst is active in metathesis reactions even when used in the absence of a conventional co-catalyst and allows problems due to the formation of isomers or side-reactions to be reduced, obtaining a high selectivity.

In accordance with the above, an object of the present invention therefore relates to a heterogeneous catalyst active in the metathesis reaction of olefins, comprising alumina as inert carrier and a rhenium compound as active component, characterized in that rhenium is present in an amount of less than 5% by weight with respect to the total, preferably from 1 to 4% by weight, and the inert carrier is impregnated with at least one inorganic halide selected from FeCl₃, CuCl₂, TiCl₄, RuCl₃, ZnCl₂ and NH₄Cl, and/or the corresponding bromides or iodides, and subsequently treated at a high temperature.

According to the present invention, alumina is preferably used as inert carrier, with a surface area ≧50 m²/g, preferably from 100 to 200 m²/g, and a total cumulative pore volume higher than 0.1 ml/g, preferably from 0.3 to 0.8 ml/g.

The rhenium compound can be introduced into the carrier, possibly pretreated at a temperature ranging from 100 to 600° C., in the presence of a stream of air, either contemporaneously with the halide or separately, through precipitation or impregnation starting from precursors consisting, for example, of solutions of its salts or soluble complexes.

The rhenium precursors are selected from rhenium heptoxide, ammonium perrhenate, tetra-alkyl ammonium perrhenate, perrhenic acid, or from other compounds known to experts in the art.

Impregnation of the inert carrier using a saturated solution of the rhenium compound, in a solvent selected from water or an organic solvent, for example a hydrocarbon, an alcohol or an ether, is generally preferred.

The impregnation is preferably carried out at a temperature ranging from 10 to 90° C. in order to increase the solubility of the rhenium salt; in this case, the carrier is also heated to the same temperature.

The inorganic halide is introduced by using aqueous or organic solutions having a salt concentration ranging from 1% by weight to saturation. The compound containing rhenium can also be dissolved in this solution, or not.

Alumina is maintained in the presence of the halogenated compound solution for a period of time ranging from 0.5 to 24 hrs, preferably from 8 to 15 hrs at a temperature ranging from 10 to 90° C.

After the impregnation of the carrier with the rhenium precursor and inorganic halides, the catalyst is activated by means of a pre-calcination at a temperature ranging from 100 to 200° C. under a flow of dry air and a subsequent calcination at a temperature ranging from 300 to 600° C., under a flow, first of dry air and subsequently of nitrogen. The cooling is carried out in a flow of nitrogen for a time ranging from 5 to 30 minutes, preferably from 10 to 20 minutes.

To obtain a further improvement of the catalyst, it is possible to wet it, after the above-mentioned treatment, with an amount of water equal to the porosity of the carrier, and calcine it again according to the method described above.

The catalysts of the present invention can be used in metathesis reactions of olefins.

Said reactions can be homo-metathesis (when the two olefins are the same) or co-metathesis (when the two olefins are different).

The olefins which can be subjected to metathesis reactions are mono-olefins having from 2 to 30 carbon atoms, such as, for example, ethylene, propylene, butene, pentene, hexene; cycloolefins having from 5 to 20 carbon atoms, for example cyclopentene, cyclooctene, norbornene; olefins having two or more unsaturations, containing from 5 to 30 carbon atoms, for example 1,4-hexadiene, 1,7-octadiene, cyclopolyolefins containing two or more unsaturations and having from 5 to 30 carbon atoms, for example 1,5-cyclooctadiene, norbordiene, dicyclopentadiene.

Other olefins are mono-olefins or olefins containing several unsaturations, linear or cyclic, carrying functional groups, such as, for example, halogens or ester groups such as methyl oleate.

The metathesis reaction can be carried out both in batch and in continuous operations, by feeding the substrates into a fluid bed or fixed bed reactor. The reaction conditions, such as temperature, pressure and flow rates are selected in relation to the feed stream and the end-product to be obtained.

The metathesis reaction is normally carried out at a temperature ranging from 0 to 100° C., preferably from 25 to 60° C., and a pressure of up to 10 MPa, preferably from 0.1 to 6 MPa and can be carried out in gaseous or liquid phase, with or without an organic solvent.

When a solvent is used, this is selected from ethers, aliphatic and aromatic hydrocarbons. Examples of these solvent are: ethyl ether, hexane, heptane, toluene, etc.

The catalyst is normally dispersed in the reaction medium at a concentration ranging from 1 to 50% by weight, preferably from 1 to 10% by weight, of the total composition.

The metathesis reaction can be optionally carried out in the presence of co-catalysts selected from alkyl metals such as, for example, tin tetraalkyls (tin tetramethyl, tin tetraethyl, tin tetrabutyl), or other alkyl metals such as lead tetramethyl, lead tetraethyl, aluminum triethyl, chloro-aluminum diethyl, as described in U.S. Pat. No. 3,855,338.

The following examples are illustrative but non-limiting of the invention described.

### EXAMPLE 1

Preparation of Catalyst A

10 g of γ-alumina with a specific surface of 180 m²/g and a porosity of 0.5 ml/g, are pre-calcined in a muffle at 110° C. for 1 hour in a flow of air and subsequently at 550° C. for 4 hours in a flow of air.

The carrier is then treated with 5 ml of a hexane solution containing 80 μl of TiCl₄, and is maintained for 18 hrs at 25° C. The liquid phase is then evaporated maintaining the sample in an oven for 2 hrs at 60° C.

The carrier is subsequently wetted with 5 ml of an aqueous solution containing 0.5 g of NH₄ReO₄, and is maintained for 18 hrs at 25° C. The liquid phase is then evaporated maintaining the sample in an oven for 2 hrs at 60° C.

The carrier is then calcined first at 110° C. for 1 hour in a flow of dry air and subsequently at 550° C. for 3 hours in a flow of dry air and 1 hour in a flow of nitrogen and is cooled for 15 minutes in a flow of argon.

The catalyst thus prepared has a rhenium content of 3.5% by weight.

### EXAMPLE 2

Use of Catalyst A in Metathesis

360 mg of catalyst A prepared as in example 1 and 40 ml of a solution consisting of 10 μl of co-catalyst SnMe₄ in 100 ml of hexane are charged into a 200 ml tailed flask, in an argon atmosphere.

The resulting mixture is maintained under gently stirring, at 25° C. for 10 minutes and 50 ml of 1-hexene are subsequently added.

The reaction mixture is analyzed, after 10 minutes, by means of gas chromatography, using an internal standard. The following results are obtained:

conversion of 1-hexene 70%

selectivity of 5-decene 100%

### EXAMPLE 3

Preparation of Catalyst B

10 g of γ-alumina with a specific surface of 180 m²/g and a porosity of 0.5 ml/g, are pre-calcined in a muffle at 110° C. for 1 hour in a flow of air, then at 550° C. for 4 hours in a flow of air.

The carrier is then wetted with 5 ml of an aqueous solution containing 0.2 g of CuCl₂ and 0.50 g of NH₄ReO₄, and is maintained or 18 hours at 60° C. The carrier thus treated is calcined first at 110° C. for 1 hour in a flow of dry air and subsequently at 550° C. for 3 hours in a flow of dry air and 1 hour in a flow of argon

The catalyst thus prepared has a rhenium content of 3.5% by weight.

### EXAMPLE 4

Use of Catalyst B in Metathesis

360 mg of catalyst B prepared as in example 3 and 40 ml of a solution consisting of 2.5 μl of co-catalyst SnMe₄ in 100 ml of hexane, are charged into a 200 ml tailed flask, in an argon atmosphere.

The resulting mixture is maintained under gently stirring, at 25° C. for 10 minutes and 50 ml of 1-hexene are subsequently added.

The reaction mixture is analyzed, after 10 minutes, by means of gas chromatography using an internal standard. The following results are obtained:

conversion of 1-hexene 65%

selectivity of 5-decene 100%

### EXAMPLE 5 (COMPARATIVE)

Preparation of Catalyst C

10 g of γ-alumina with a specific surface of 180 m²/g and a porosity of 0.5 ml/g, are pre-calcined in a muffle at 110° C. for 1 hour in a flow of air and subsequently at 550° C. for 4 hours in a flow of air.

The carrier is then wetted with 5 ml of an aqueous solution containing 1.12 g of NH₄ReO₄. The water is subsequently evaporated maintaining the sample in an oven at 60° C.

The catalyst is then calcined first at 110° C. for 1 hour in a flow of dry air and subsequently at 550° C. for 3 hours in a flow of dry air and 1 hour in a flow of nitrogen. Then the reactor is get out the muffle and is cooled for 15 minutes in a flow of argon.

The catalyst thus prepared has a rhenium content of 7.5% by weight.

### EXAMPLE 6 (COMPARISON)

Use of Catalyst C in Metathesis

360 mg of catalyst C prepared as in example 3 and 23 ml of a solution consisting of 10 μl of co-catalyst SnMe₄ in 100 ml of hexane, are charged into a 150 ml tailed flask, in an argon atmosphere.

The resulting mixture is maintained under gently stirring, at 25° C. for 10 minutes and 26 ml of 1-hexene are subsequently added.

The reaction mixture is analyzed, after 30 minutes, by means of gas chromatography, using an internal standard. The following results are obtained:

conversion of 1-hexene 3%

selectivity of 5-decene 100%.

### EXAMPLE 7 (COMPARISON)

Preparation of Catalyst D

10 g of γ-alumina with a specific surface of 180 m²/g and a porosity of 0.5 ml/g, are calcined in a muffle at 110° C. for 1 hour in a flow of air and subsequently at 550° C. for 4 hours in a flow of air.

The carrier is then wetted with 5 ml of an aqueous solution containing 0.5 g of NH₄ReO₄, the water is evaporated by maintaining the sample in an oven at 60° C.

The catalyst is calcined first at 110° C. for 1 hour in a flow of dry air and subsequently at 550° C. for 3 hours in a flow of dry air and 1 hour in a flow of nitrogen. The reactor is get out the muffle and is cooled for 15 minutes in a flow of nitrogen.

The catalyst thus prepared has a rhenium content of 3.5% by weight.

### EXAMPLE 8 (COMPARISON)

Use of Catalyst D in Metathesis

360 mg of catalyst D prepared as in example 5 and 23 ml of a solution consisting of 10 μl of co-catalyst SnMe₄ in 100 ml of hexane are charged into a 150 ml tailed flask, in an argon atmosphere.

The resulting mixture is maintained under light stirring, at 25° C. for 10 minutes and 26 ml of 1-hexene are subsequently added.

The reaction mixture is analyzed, after 10 minutes, by means of gas chromatography, using an internal standard. The following results are obtained:

conversion of 1-hexene 15%

selectivity of 5-decene 85%.

### EXAMPLE 9 (COMPARISON)

Preparation of Catalyst E

10 g of γ-alumina with a specific surface of 180 m²/g and a porosity of 0.5 ml/g, are pre-calcined in a muffle at 110° C. for 1 hour in a flow of air and subsequently at 550° C. for 4 hours in a flow of air.

The carrier is then wetted with 5 ml of an aqueous solution containing 57 mg of HCl and 0.5 g of NH₄ReO₄, and is maintained for 18 hours at 60° C. The carrier thus treated is calcined first at 110° C. for 1 hour in a flow of dry air and subsequently at 550° C. for 3 hours in a flow of dry air and 1 hour in a flow of argon.

The catalyst thus prepared has a rhenium content of 3.5% by weight.

### EXAMPLE 10 (COMPARISON)

Use of Catalyst E in Metathesis

360 mg of catalyst E prepared as in example 3 and 20 ml of a solution consisting of 10 μl of co-catalyst SnMe₄ in 100 ml of hexane are charged into a 150 ml tailed flask, in an argon atmosphere.

The resulting mixture is maintained under light stirring, at 25° C. for 10 minutes and 20 g of 1-hexene are subsequently added.

The reaction mixture is analyzed, after 10 minutes, by means of gas chromatography, using an internal standard. The following results are obtained:

conversion of 1-hexene 47%

selectivity of 5-decene 98%.

### EXAMPLE 11 (COMPARISON)

Preparation of Catalyst F

10 g of γ-alumina with a specific surface of 180 m²/g and a porosity of 0.5 ml/g, are pre-calcined in a muffle at 110° C. for 1 hour in a flow of air and subsequently at 550° C. for 4 hours in a flow of air.

The carrier is then wetted with 5 ml of an aqueous solution containing 200 mg of MnCl₂ and 0.5 g of NH₄ReO₄, and is maintained for 18 hours at 60° C. The carrier thus treated is calcined first at 110° C. for 1 hour in a flow of dry air and subsequently at 550° C. for 3 hours in a flow of dry air and 1 hour in a flow of argon.

The catalyst thus prepared has a rhenium content of 3.5% by weight.

### EXAMPLE 12 (COMPARISON)

Use of Catalyst F in Metathesis

360 mg of catalyst E prepared as in example 3 and 20 ml of a solution consisting of 10 μl of co-catalyst SnMe₄ in 100 ml of hexane, are charged into a 150 ml tailed flask, in an argon atmosphere.

The resulting mixture is maintained under gently stirring, at 25° C. for 10 minutes and 20 g of 1-hexene are subsequently added.

The reaction mixture is analyzed, after 10 minutes, by means of gas chromatography, using an internal standard. The following results are obtained:

conversion of 1-hexene 50%

selectivity of 5-decene 88%.

1. A heterogeneous catalyst, active in the metathesis reaction of olefins comprising alumina as inert carrier and a rhenium compound as active component, wherein rhenium is present in an amount of less than 5% by weight with respect to the total, and the inert carrier is impregnated with at least one inorganic halide selected from the group of inorganic halides consisting of FeCl₃, CuCl₂, TiCl₄, RuCl₃, ZnCl₂ and NH₄Cl, and the corresponding bromides and iodides, and subsequently treated at a high temperature.

2. The catalyst according to claim 1, wherein the alumina has a specific surface area greater than 50 m²/g and a total cumulative pore volume greater than 0.01 ml/g.

3. The catalyst according to claim 2, wherein the alumina has a specific surface area ranging from 100 to 200 m²/g and a total cumulative pore volume ranging from 0.3 to 0.8 ml/g.

4. The catalyst according to claim 1, wherein the rhenium compound can be introduced into the carrier, optionally pretreated at a temperature ranging from 100 to 600° C., in the presence of a stream of air, either contemporaneously with the halide or separately, through precipitation or impregnation starting from precursors.

5. The catalyst according to claim 1, wherein the rhenium active component is introduced onto the carrier by means of precipitation or impregnation starting from its precursors in the form of solutions of its salts or soluble complexes.

6. The catalyst according to claim 5, wherein the rhenium precursors are at least one selected from the group of rhenium precursors consisting of rhenium heptoxide, ammonium perrhenate, tetra-alkyl ammonium perrhenate and perrhenic acid.

7. The catalyst according to claim 1, wherein the inorganic halide is introduced by using aqueous or organic solutions having an inorganic halide concentration ranging from 1% by weight to saturation.

8. The catalyst according to claim 7, wherein the alumina is maintained in the presence of the inorganic halide solution for a period of time ranging from 0.5 to 24 hrs, at a temperature ranging from 10 to 90° C.

9. The catalyst according to claim 1, wherein the catalyst, after the impregnation of the carrier with the rhenium precursor and inorganic halides, is activated through pre-calcination at a temperature ranging from 100 to 200° C. under a flow of dry air and a subsequent calcination at a temperature ranging from 300 to 600° C., under a flow, first of dry air and subsequently of nitrogen.

10. A process for the conversion of olefins by means of a metathesis reaction, wherein the metathesis reaction is carried out in the presence of a catalyst according to claim 1.

11. The process according to claim 10, wherein the metathesis reaction can be homo-metathesis or co-metathesis.

12. The process according to claim 10, wherein the olefins are at least one selected from the group of olefins consisting of monoolefins having from 2 to 30 carbon atoms, cycloolefins having from 5 to 20 carbon atoms, polyolefins having from 5 to 30 carbon atoms, and cyclopolyolefins containing from 5 to 30 carbon atoms.

13. The process according to claim 12, wherein the monoolefins are at least one selected from the group of olefins consisting of ethylene, propylene, butene, pentene, and hexene.

14. The process according to claim 12, wherein the cycloolefins are at least one selected from the group of cycloolefins consisting of cyclopentene, cyclooctene, and norbornene.

15. The process according to claim 12, wherein the polyolefins are at least one selected from the group of polyolefins consisting of 1,4-hexadiene, and 1,7-octadiene.

16. The process according to claim 12, wherein the cyclopolyolefins are at least one selected from the group of cyclopolyolefins consisting of 1,5-cyclooctadiene, norbornadiene and dicyclopentadiene.

17. The process according to claim 12, wherein the monoolefins and polyolefins, linear or cyclic, can carry one or more functional groups selected from the group of functional groups consisting of halogens and ester groups.

18. The process according to claim 10, wherein the metathesis reaction is carried out at a temperature ranging from 0 to 100° C. and a pressure ranging from 0 to 100 bar.

19. The process according to claim 18, wherein the metathesis reaction is carried out at a temperature ranging from 25 to 60° C. and a pressure ranging from 1 to 60 bar.

20. The process according to claim 10, wherein the metathesis reaction is carried out in gas phase or liquid phase with or without a at least one solvent selected from the group of solvents consisting of ethers, aliphatic and aromatic hydrocarbons.

21. The process according to claim 20, wherein the solvent is at least one solvent selected from the group of solvents consisting of ethyl ether, hexane, heptane, and toluene.

22. The process according to claim 10, wherein the quantity of catalyst ranges from 1 to 50% by weight with respect to the reaction mixture.

23. The process according to claim 22, wherein the quantity of catalyst ranges from 1 to 10% by weight with respect to the reaction mixture.

24. The process according to claim 10, wherein the metathesis reaction is carried out batchwise or in continuous.
